(19) United States
(12) Patent Application Publication
(10) Pub. No.: US 2025/0335227 A1
(43) Pub. Date: Oct. 30, 2025

(54) VIRTUAL PROCESSOR AUTO-SUSPEND DURING VIRTUALIZATION STACK SERVICING

(71) Applicant: Microsoft Technology Licensing, LLC, Redmond, WA (US)

(72) Inventors: Kevin Michael BROAS, Kirkland, WA (US); Sai Ganesh RAMACHANDRAN, Sammamish, WA (US); Vignesh Kudigrama SHENOY, Snohomish, WA (US); Justin Sing Tong CHEUNG, Redmond, WA (US)

(21) Appl. No.: 18/645,012

(22) Filed: Apr. 24, 2024

(51) Int. Cl. G06F 9/455

(52) U.S. Cl. CPC G06F 9/45558; G06F 2009/45575

(57) ABSTRACT

Systems and methods for servicing a virtualization stack without disrupting a virtual machine (VM) include detecting a servicing operation for a component of a virtualization stack supporting the VM. Upon detecting an interrupt from a virtual processor (VP) of a partition associated with the VM during the servicing operation, it is determined that the interrupt is a root interrupt type. In response to the interrupt being the root interrupt type, the method includes holding the interrupt at a hypervisor and suspending one or more VPs of the partition. Following completion of the servicing operation, the partition's VP(s) are resumed, and the interrupt is released to a root partition.

### BACKGROUND

Hypervisor-based virtualization technologies allocate portions of a computer system's physical resources (e.g., processor resources, physical memory resources, storage resources) into separate partitions and execute software within each partition. Hypervisor-based virtualization technologies, therefore, facilitate the creation of virtual machines (VMs) that each execute guest software, such as an operating system (OS) and applications executing therein. A computer system that hosts VMs is commonly called a VM host or a VM host node.

While hypervisor-based virtualization technologies can take various forms, many use an architecture comprising a type-one, or bare-metal, hypervisor that has direct access to hardware and operates in a separate execution environment from all other software in the computer system. A type-one hypervisor creates a host (or root) partition (e.g., a host VM) and one or more guest partitions (e.g., guest VMs). Each partition comprises an isolated slice of the underlying hardware of the VM host, such as memory and processor resources. The host partition executes a host OS and a host virtualization stack that manages the guest partitions. Thus, the hypervisor grants the host partition a greater level of access to the hypervisor and to hardware resources than it does to guest partitions. Other hypervisor-based architectures comprise a type-two, or hosted, hypervisor that executes within the context of an underlying OS, and that creates one or more guest partitions.

Taking HYPER-V from MICROSOFT CORPORATION as one example, the HYPER-V hypervisor is a type-one hypervisor making up the lowest layer of a HYPER-V stack. The HYPER-V hypervisor provides basic functionality for dispatching and executing virtual processors for VMs. The HYPER-V hypervisor takes ownership of hardware virtualization capabilities (e.g., second-level address translation processor extensions such as rapid virtualization indexing from ADVANCED MICRO DEVICES or extended page tables from INTEL; an input/output (I/O) memory management unit that connects a direct memory access-capable I/O bus to main memory; processor virtualization controls). The HYPER-V hypervisor also provides a set of interfaces to allow a HYPER-V host stack within a host partition to leverage these virtualization capabilities to manage VMs. The HYPER-V host stack provides general functionality for VM virtualization (e.g., memory management, VM lifecycle management, device virtualization).

The subject matter claimed herein is not limited to embodiments that solve any disadvantages or that operate only in environments such as those described supra. Instead, this background is only provided to illustrate one example technology area where some embodiments described herein may be practiced.

### SUMMARY

In some aspects, the techniques described herein relate to methods, systems, and computer program products, including: detecting a servicing operation for a component of a virtualization stack that supports the execution of a virtual machine (VM); detecting a first interrupt from a first virtual processor (VP) of a partition associated with the VM while the component of the virtualization stack is being serviced; determining that the first interrupt is a root interrupt type; based on the first interrupt being the root interrupt type, holding the first interrupt at a hypervisor and suspending the first VP; and after completion of the servicing operation, resuming the first VP and releasing the first interrupt to a root partition.

In some aspects, the techniques described herein relate to methods, systems, and computer program products, including: detecting a servicing operation for a component of a virtualization stack that supports the execution of a VM; detecting a first interrupt from a first VP of a partition associated with the VM while the component of the virtualization stack is being serviced; determining that the first interrupt is a root interrupt type; determining that processing of the first interrupt would rely on the component of the virtualization stack to which the servicing operation applies; based on the first interrupt being the root interrupt type and based on the processing of the first interrupt relying on the component of the virtualization stack to which the servicing operation applies, holding the first interrupt at a hypervisor and suspending the first VP; and after completion of the servicing operation for the component of the virtualization stack to which the servicing operation applies, resuming the first VP and releasing the first interrupt to a root partition.

In some aspects, the techniques described herein relate to methods, systems, and computer program products, including: detecting a servicing operation for a component of a virtualization stack that supports the execution of VM; in response to detecting a first interrupt from a first VP of a partition associated with the VM while the component of the virtualization stack is being serviced: determining that the first interrupt is a root interrupt type; and based on the first interrupt being the root interrupt type, holding the first interrupt at a hypervisor and suspending the first VP; in response to detecting a second interrupt from a second VP of the partition associated with the VM while the component of the virtualization stack is being serviced: determining that the second interrupt is a synthetic interrupt type; and based on the second interrupt being the synthetic interrupt type, holding the second interrupt at the hypervisor while permitting the second VP to continue running or returning a timeout status VP while permitting the second VP to continue running; and after completion of the servicing operation, resuming the first VP and releasing the first interrupt to a root partition.

This Summary introduces a selection of concepts in a simplified form that are further described below in the Detailed Description. This Summary is not intended to identify key features or essential features of the claimed subject matter, nor is it intended to be used to determine the scope of the claimed subject matter.

### BRIEF DESCRIPTION OF THE DRAWINGS

To describe how the advantages of the systems and methods described herein can be obtained, a more particular description of the embodiments briefly described supra is rendered by reference to specific embodiments thereof, which are illustrated in the appended drawings. These drawings depict only typical embodiments of the systems and methods described herein and are not, therefore, to be considered to be limiting in their scope. Systems and methods are described and explained with additional specificity and detail through the use of the accompanying drawings, in which:

FIG. 1 illustrates an example of a computer architecture that facilitates servicing a virtualization stack without suspending the virtual processors (VPs) of a guest virtual machine (VM);

FIG. 2 illustrates an example of a virtualization stack servicing component that utilizes VP auto-suspend during VM stack maintenance; and

FIGS. 3A-3B illustrate a flow chart of an example of a method of servicing a virtualization stack without disrupting a VM.

### DETAILED DESCRIPTION

A virtualization stack may need to be serviced occasionally, for example, to update the hypervisor, the root operating system (OS), or other virtualization components. Early virtualization stack servicing techniques tear down and re-create any virtual processors (VPs) associated with affected guest virtual machines VM(s). This means there is significant disruption to these guest VMs and their workloads during servicing. Newer virtualization stack servicing techniques preserve guest VM VPs during the servicing (e.g., the VPs are not destroyed and re-created). Nonetheless, even these newer servicing techniques explicitly suspend VPs during the servicing, leading to guest VM interruption during VP suspension. Thus, a common feature of virtualization stack servicing solutions is that the VPs of affected guest VMs cease execution during the servicing, either by being torn down and re-created or by being suspended, thereby guaranteeing disruption of any guest VM(s) reliant on a virtualization stack that is being serviced.

Embodiments disclosed herein are directed to methods and systems for servicing a virtualization stack without disrupting guest VM(s) that rely on that virtualization stack. Embodiments include putting a guest VM's partition into an auto-suspend mode during virtualization stack servicing. In this auto-suspend mode, a hypervisor does not explicitly tear down or suspend guest VM VPs due merely to the virtualization stack servicing. Instead, in the auto-suspend mode, the hypervisor allows a guest VM's VPs to keep running unless a VP generates an interrupt that requires processing by a root partition (a “root interrupt”). In that case, the hypervisor suspends one or more of the guest VM's VPs and holds the root interrupt until the virtualization stack servicing is complete. Sometimes, for a given root interrupt, the hypervisor may be able to suspend only a subset (i.e., less than all) of the guest VM's VPs. Thus, all of the VP(s) of a guest VM can continue operating during virtualization stack servicing until one of them generates a root interrupt and, in some cases, one or more of the guest VM(s) VP(s) may even be able to continue operating even after one of the VP(s) generates a root interrupt. Notably, if a guest VM's VP(s) do not generate any root interrupt during virtualization stack servicing, all of that guest VM VP(s) can continue operating uninterrupted during the entirety of the virtualization stack servicing.

Therefore, the embodiments described herein enable a guest VM's VPs to continue running during virtualization stack servicing unless the guest VM generates a root interrupt. Because virtualization stack servicing does not automatically cause disruption to guest VMs, the embodiments described herein achieve enhanced performance and availability of guest VMs during virtualization stack servicing than was previously possible.

In addition to providing enhanced performance and availability of guest VMs during virtualization stack servicing, the embodiments described herein reduce the administrative burden of managing VM hosts because the virtualization stack at a VM host can be serviced with reduced disruption to the guest VM(s) relying thereon. This means virtualization stacks can generally be kept more up-to-date, with reduced guest VM disruption, than was previously possible. VM host administrators, therefore, have increased flexibility to service virtualization stacks to add features, fix bugs, and address security vulnerabilities, resulting in increased feature availability, performance, reliability, and security.

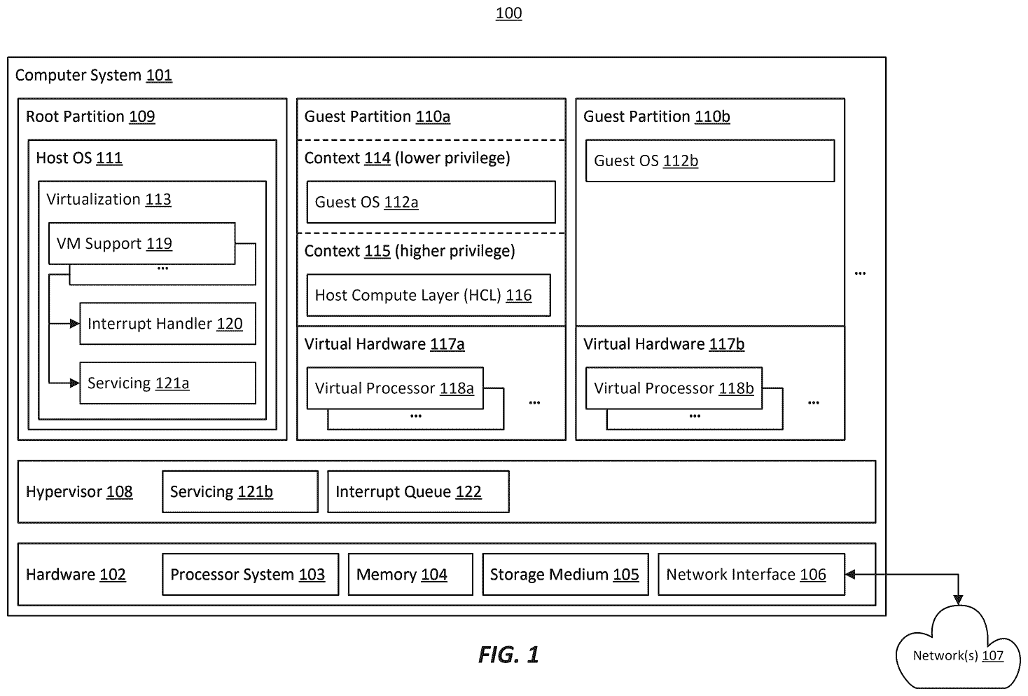

FIG. 1 illustrates an example of a computer architecture 100 that facilitates servicing a virtualization stack without suspending the VP(s) of a guest VM. As shown, computer architecture 100 includes a computer system 101 (e.g., a VM host) that comprises hardware 102. Examples of hardware 102 include a processor system 103 (e.g., a single processor, or a plurality of processors), a memory 104 (e.g., system or main memory), a storage medium 105 (e.g., a single computer-readable storage medium, or a plurality of computer-readable storage media), and a network interface 106 (e.g., one or more network interface cards) for interconnecting, via network(s) 107, to one or more other computer systems (not shown). Although not shown, hardware 102 may also include other hardware devices, such as a trusted platform module (TPM) for facilitating measured boot features, an input/output (I/O) memory management unit (IOMMU) that connects a direct memory access (DMA)-capable I/O bus to memory 104, a video display interface for connecting to display hardware, a user input interface for connecting to user input devices, an external bus for connecting to external devices, and the like.

As shown, in computer architecture 100, a hypervisor 108 is a type-one hypervisor that executes directly on hardware 102. However, the embodiments herein are also applicable to type-two hypervisor environments. As shown, hypervisor 108 partitions hardware resources (e.g., processor system 103, memory 104, I/O resources) among a root partition 109 and one or more guest partitions 110 (e.g., guest VMs), such as guest partition 110a, guest partition 110b, and so on. As shown, hypervisor 108 presents each guest partition of guest partitions 110 with corresponding virtual hardware 117, such as one or more VPs 118. For example, FIG. 1 illustrates guest partition 110a as including virtual hardware 117a, comprising VP 118a (or a plurality of VPs) and potentially other virtual hardware (e.g., a virtual network interface, a virtual storage controller, and the like), and illustrates guest partition 110b as including virtual hardware 117b, comprising VP 118b (or a plurality of VPs) and potentially other virtual hardware (e.g., a virtual network interface, a virtual storage controller, and the like).

As shown, an OS and other software execute within the context of each partition. For example, host OS 111 executes within root partition 109, and includes a virtualization component 113, which manages and supports guest partitions 110 (e.g., via VP management, memory management, lifecycle management, and the like) via application program interface (API) calls to hypervisor 108. In this description, and the claims, the term “virtualization stack” collectively refers to hypervisor 108, host OS 111, and/or virtualization component 113. Additionally, each guest partition of guest partitions 110 executes a corresponding guest OS 112 (e.g., guest OS 112a within guest partition 110a, guest OS 112b within guest partition 110b, and so on) that may further execute a guest workload.

In FIG. 1, virtualization component 113 includes one or more VM support components 119. Each VM support component 119 provides functionality to virtualization component 113 to create, manage, and support guest partitions 110. As examples, various VM support components 119 may provide VM worker threads (e.g., one corresponding to each guest partition), paravirtual devices (e.g., which multiplex VM guest access to a device within hardware 102), memory management facilities, and direct peripheral component interconnect (PCI) device assignment functionality. To describe embodiments of servicing a virtualization stack without disrupting guest VM(s) that rely on that virtualization stack, computer architecture 100 is shown as including VM support components 119 in the form of an interrupt handler component 120 and a servicing component 121a, which will be described later. It will be appreciated, however, that virtualization component 113 may contain various other VM support components 119.

The guest partitions 110 can take various forms. Conventionally, guest OSs have had full access to their respective partitions. This means that a guest OS has conventionally had full access to and control of virtual hardware presented by the hypervisor to the guest partition, such as VPs, guest virtual memory, virtual hardware devices, and the like. For example, in guest partition 110b, an entirety of the partition's memory space is available to guest OS 112b.

More recently, however, some hypervisors have further divided guest partitions into different privilege contexts, such as a lower-privileged context and a higher-privileged context. For example, guest partition 110a comprises a first guest context (context 114) and a second guest context (context 115). In embodiments, context 114 is a lower privileged context (e.g., when compared to context 115), and context 115 is a higher privileged context (e.g., when compared to context 114). In these embodiments, context 114 having a lower privilege than context 115 means that context 114 cannot access guest partition memory allocated to context 115. In various embodiments, context 115 has access to guest partition memory allocated to context 114. In other embodiments, context 115 lacks access to guest partition memory allocated to context 114. In FIG. 1, context 115 executes software (e.g., a kernel, and processes executing thereon) separately from context 114 and provides one or more services to guest OS 112a. Thus, context 115 is shown as operating a host compute layer (HCL), HCL 116. In embodiments, HCL 116 includes hypervisor-like functionality to context 114 and thus operates, at least in part, as a para-virtualization layer (e.g., a “paravisor”) and/or a virtual machine monitor (VMM). Examples of services that HCL 116 may provide to context 114 include emulated hardware (e.g., an emulated non-volatile memory express (NVMe) controller), baseboard management controller functionality for monitoring and managing a guest partition, a virtual trusted platform module, and the like.

Some embodiments create context 114 and context 115 by leveraging second-level address translation (SLAT) to create isolated memory contexts within guest partition 110a. For example, HYPER-V includes virtualization-based security (VBS) technology that relies on SLAT. Using VBS, the HYPER-V hypervisor can sub-partition a guest partition's guest memory into different virtual trust levels (VTLs), including, for example, a higher-privileged VTL (e.g., VTL2) and a lower-privileged VTL (e.g., VTL0). In these environments, the guest OS executes within the lower-privileged VTL (e.g., VTL0), while separate software executes in the higher-privileged VTL (e.g., VTL2) and provides services to the guest OS. Thus, in embodiments, hypervisor 108 creates context 114 and context 115 using one or more SLAT tables that map system physical addresses within memory 104 to guest physical addresses seen by guest partition 110a. In these embodiments, these mappings prevent context 114 from accessing memory allocated to context 115. In one example, hypervisor 108 is the HYPER-V hypervisor, which utilizes VBS to create different VTLs. In this example, context 115 operates under VBS in a higher privileged VTL (e.g., VTL2), and context 114 operates under VBS in a lower privileged VTL (e.g., VTL0).

Other embodiments create context 114 and context 115 using nested virtualization, e.g., in which guest partition 110a operates a hypervisor that partitions guest partition 110a resources into sub-partitions. In these embodiments, this hypervisor operating within guest partition 110a prevents context 114 from accessing memory allocated to context 115. Other embodiments are also possible, such as embodiments in which hypervisor 108 creates both guest partition 110a and sub-partitions within guest partition 110a.

In embodiments, computer architecture 100 enables the servicing of a virtualization stack (e.g., servicing one or more of hypervisor 108, host OS 111, and/or virtualization component 113—including VM support components 119) without disrupting the guest VM(s) corresponding to guest partitions 110. These embodiments are referred to herein as VP auto-suspend. In embodiments, during virtualization stack servicing, a servicing component 121 (e.g., servicing component 121a, servicing component 121b) puts one or more guest partitions of guest partitions 110 into an auto-suspend mode. In this auto-suspend mode, hypervisor 108 does not explicitly tear down or suspend VPs 118 due merely to the virtualization stack servicing. Instead, in the auto-suspend mode, hypervisor 108 allows the VP(s) of any guest partition that is in the auto-suspend mode to keep running unless a VP generates a root interrupt. In that case, hypervisor 108 suspends at least that VP and holds the root interrupt (e.g., interrupt queue 122) until the virtualization stack servicing is complete. Sometimes, for a given root interrupt, hypervisor 108 may be able to suspend only a subset (i.e., less than all) of the guest VM's VPs. Thus, all of the VP(s) of a guest VM can continue operating during virtualization stack servicing until one of those VPs generates a root interrupt. In some cases, one or more of the guest VM(s) VP(s) may even be able to continue operating even after one of the VP(s) generates a root interrupt. After the virtualization stack servicing is complete, the hypervisor 108 delivers any held interrupts (e.g., to root partition 109) and resumes any VP(s) that were suspended due to generating a root interrupt.

In these embodiments, so long as a guest VM's VP(s) do not generate any root interrupt during virtualization stack servicing, that guest VM can continue operating uninterrupted during the virtualization stack servicing. Notably, these embodiments may be especially beneficial for VMs with less dependency on root partition 109. For example, due to the presence of HCL 116 (which, e.g., can host its own virtual devices, and/or can generate synthetic interrupts instead of root interrupts), guest partition 110a may be more able to avoid the use of root interrupts than guest partition 110b. Additionally, a guest VM that utilizes a directly assigned PCI device may be better able to avoid the use of root interrupts than a guest VM that utilizes a para-virtualized device provided by virtualization component 113.

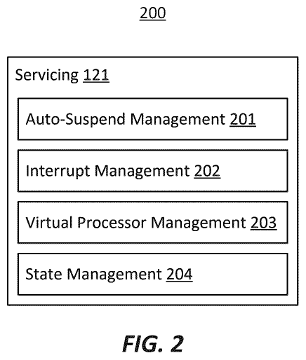

The foregoing VP auto-suspend functionality is represented by servicing component 121. As shown, servicing component 121 may comprise functionality at root partition 109, represented as servicing component 121a, and/or functionality at hypervisor 108, represented as servicing component 121b. FIG. 2 illustrates an example 200 of servicing component 121, which utilizes VP auto-suspend during VM stack maintenance. Each component of servicing component 121 depicted in FIG. 2 represents various functionalities that servicing component 121 may implement under the embodiments described herein. These components—including their identity and arrangement—are presented merely as an aid in describing example embodiments of servicing component 121.

In FIG. 2, servicing component 121 includes an auto-suspend management component 201. In embodiments, when a virtualization stack servicing operation begins, the auto-suspend management component 201 sets an auto-suspend property for one or more guest partitions of guest partitions 110. With this property set for a partition, any interrupts generated by that partition are analyzed by servicing component 121 (interrupt management component 202) and, when appropriate, one or more of that partition's VP(s) are suspended. Additionally, when the virtualization stack servicing operation ends, the auto-suspend management component 201 clears the auto-suspend property for those guest partition(s), restoring the regular operation of those guest partition(s).

In some embodiments, the auto-suspend management component 201 resides at root partition 109 (e.g., servicing component 121a), and the auto-suspend management component 201 sets and clears auto-suspend properties based on hypercalls to hypervisor 108. In other embodiments, the auto-suspend management component 201 resides at hypervisor 108 (e.g., servicing component 121b), and the auto-suspend management component 201 sets and clears auto-suspend properties directly.

Servicing component 121 also includes an interrupt management component 202. In embodiments, interrupt management component 202 intercepts interrupts from at least partitions having the auto-suspend property. The interrupt management component 202 then determines the interrupt's type. In embodiments, interrupt management component 202 determines two general categories of interest type—root interrupts and synthetic interrupts—and the type dictates how these interrupts are handled for a partition in the auto-suspend mode.

In embodiments, root interrupts are generated when a guest VM performs an operation that traps to the root partition 109, such as to access a para-virtual device or execute a privileged instruction (e.g., CPUID). In embodiments, when interrupt management component 202 intercepts a root interrupt, it triggers a suspension of one or more VP(s) associated with the guest VM that caused the interrupt, and it holds the interrupt at interrupt queue 122 until the virtualization stack servicing is complete. When the virtualization stack servicing is complete, interrupt management component 202 delivers held root interrupts to root partition 109 and triggers the resumption of the suspended VP(s). In embodiments, depending on the type of root interrupt, the component being serviced, etc., interrupt management component 202 may trigger suspension of all of a guest VM(s) VPs, or only a subset thereof (e.g., just the VP that triggered the interrupt). For example, interrupt management component 202 may trigger suspension of all of a guest VM's VP in cases where there is a risk that suspending a single VP would lead to a stall of that VP being detected by other VPs or the guest OS. For instance, a guest OS may have a watchdog timer intended to detect stalls and trigger a critical error (e.g., kernel panic, bugcheck) if it appears forward progress is not being made. In some embodiments, interrupt management component 202 suspends all of a guest VM's VPs immediately when any VP has a root interrupt. In other embodiments, interrupt management component 202 suspends all of a guest VM's VPs after a period of time (e.g., nine seconds after any VP is suspended, all VPs are suspended).

Synthetic interrupts, on the other hand, are generated by the guest VM when it engages in synthetic messaging (e.g., signaling VM bus as part of a synthetic I/O request), when it makes a hypercall to communicate with root partition 109, and the like. In embodiments, when interrupt management component 202 intercepts a synthetic interrupt, it permits the VP(s) associated with the guest VM that caused the interrupt to continue operating unsuspended. However, interrupt management component 202 either returns a timeout status to the guest VM or holds the synthetic interrupt at interrupt queue 122 until the virtualization stack servicing is complete. In embodiments, if some limit is reached (e.g., a number or frequency of held synthetic interrupts from a given VP), interrupt management component 202 clears the held synthetic interrupts and returns a timeout status. When the virtualization stack servicing is complete, interrupt management component 202 delivers held synthetic interrupts to root partition 109.

Some implementations operate to reduce the number of root and/or synthetic interrupts that are generated by a guest VM during virtualization stack servicing. For example, embodiments may unregister specific root and/or synthetic interrupts with the guest VM during virtualization stack servicing, preventing the guest VM from generating those interrupts during virtualization stack servicing.

Servicing component 121 also includes a VP management component 203. As mentioned, when interrupt management component 202 intercepts a root interrupt, it triggers a suspension of one or more VP(s) associated with the guest VM that caused the interrupt. In embodiments, VP management component 203 manages the suspension and resumption of VPs based on instructions from communications from interrupt management component 202.

Servicing component 121 also includes a state management component 204. In embodiments, the state management component 204 manages the saving and restoring of the state of the virtualization stack component(s) being serviced. Notably, prior virtualization stack servicing techniques, in which VPs were torn down or suspended during servicing, would generally serialize a component's state into a state blob, service that component, and then deserialize the state blob to restore the component's state. However, the embodiments herein enable VPs to continue operating absent a root intercept. Thus, these VPs may be able to permute a component's state during the servicing of that component. Thus, in embodiments, state management component 204 provides flexibility to handle state changes caused by the running VP(s). In embodiments, for one or more virtualization stack components, the state management component 204 defines an outline of a component's state that can or cannot be perturbed during the servicing of that component. For example, the state management component 204 defines boundaries (e.g., in terms of registers, memory locations, and the like) that can and/or cannot be modified by a VP. In embodiments, so long as a VP stays within those boundaries, and does not issue a root intercept, it can continue executing. In embodiments, if a VP exceeds those boundaries it is suspended. In embodiments, when state management component 204 restores a virtualization stack component's state, it may merge and/or reconcile the saved state with the existing values based on these defined boundaries.

In some embodiments, the virtualization stack component being serviced is hypervisor 108. In these embodiments, a first (e.g., current) instance of hypervisor 108 is run in parallel with a second (e.g., new) instance of hypervisor 108 at computer system 101, while state management component 204 mirrors the hypervisor state from the first instance to the second instance. During this period, servicing component 121b at the first instance of hypervisor 108 handles the VP auto-suspend functionality described herein (e.g., setting auto-suspend properties, intercepting interrupts, suspending VPs). Then, when the second instance of hypervisor 108 is ready, the second instance takes control of all hypervisor functionality, including VP auto-suspend functionality. Thus, for example, this second instance of hypervisor 108 handles clearing auto-suspend properties, delivering interrupts, resuming VPs, etc.

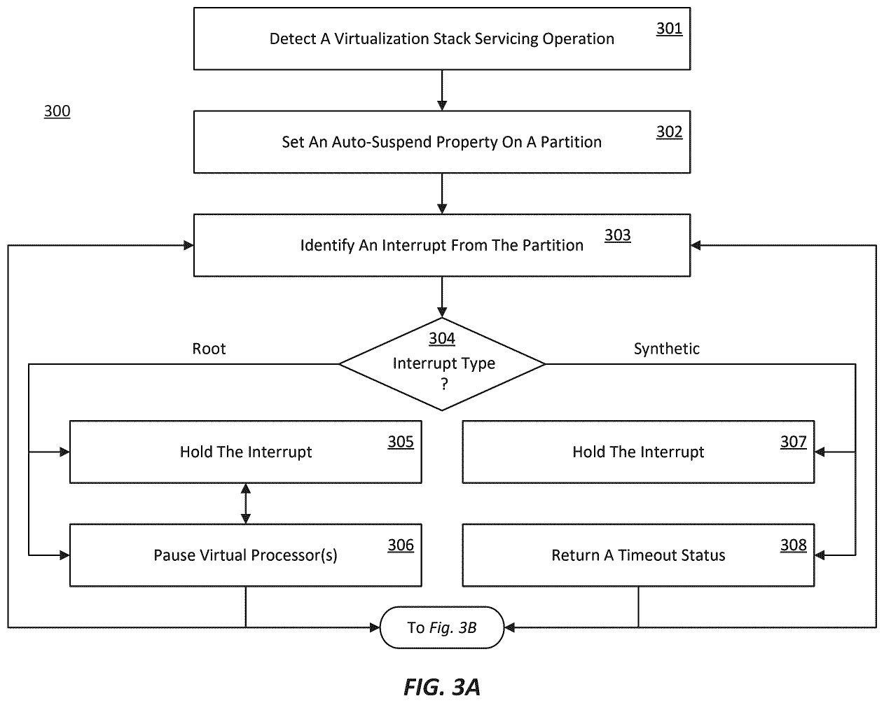

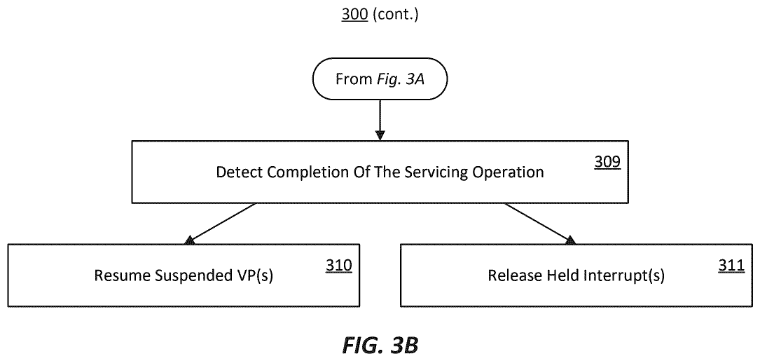

Embodiments are now described in connection with FIGS. 3A-3B, illustrating a flow chart of an example method 300 of servicing a virtualization stack without disrupting a VM. In embodiments, instructions for implementing method 300 are encoded as computer-executable instructions (e.g., servicing component 121) stored on a computer storage medium (e.g., storage medium 105) that are executable by a processor (e.g., processor system 103) to cause a computer system (e.g., computer system 101) to perform method 300.

The following discussion now refers to a method and method acts. Although the method acts are discussed in specific orders or are illustrated in a flow chart as occurring in a particular order, no order is required unless expressly stated or required because an act is dependent on another act being completed before the act is performed.

Referring initially to FIG. 3A, in embodiments, method 300 comprises act 301 of detecting a virtualization stack servicing operation. In some embodiments, act 301 comprises detecting a servicing operation for a component of a virtualization stack that supports the execution of a VM. For example, the auto-suspend management component 201 determines that a component of the virtualization stack (e.g., host OS 111, one or more of VM support components 119, hypervisor 108) is being serviced (e.g., updated, restarted).

In embodiments, method 300 also comprises act 302 of setting an auto-suspend property on a partition. In some embodiments, act 302 sets a partition property for the partition associated with the VM. For example, based on the servicing of the virtualization stack, the auto-suspend management component 201 sets a property on one or more guest partitions of guest partitions 110, such as guest partition 110a and guest partition 110b. In embodiments, the partition property indicates an auto-suspend mode that allows one or more VPs associated with the partition to continue running unless the VP generates an interrupt of the root interrupt type. In embodiments, based on the partition property, hypervisor 108 intercepts and analyzes interrupts received from a partition to determine if the interrupt should be held, if a VP should be suspended, etc. In some embodiments, the partition property is set based on a hypercall from the virtualization stack to the hypervisor (e.g., a call from servicing component 121a to hypervisor 108).

Method 300 also comprises act 303 of identifying an interrupt from the partition. In some embodiments, act 303 comprises detecting an interrupt from a VP of a partition associated with the VM while the component of the virtualization stack is being serviced. For example, interrupt management component 202 detects and intercepts an interrupt generated by VP 118a of guest partition 110a.

Method 300 also comprises act 304 of determining an interrupt type. In some instances, act 304 comprises determining that the interrupt is a root interrupt type. For example, interrupt management component 202 determines that the interrupt is of a type that traps to root partition 109 for handling by an interrupt handler at root partition 109 (e.g., interrupt handler component 120, such as a paravirtual device). In other instances, act 304 comprises determining that the interrupt is a synthetic interrupt type. For example, interrupt management component 202 determines that the interrupt is of a type for communicating with root partition 109, such as a hypercall from guest partition 110a to root partition 109.

Following the “Root” branch from act 304, in some instances, based on determining that the interrupt is the root interrupt type in act 304, method 300 comprises act 305 of holding the interrupt, as well as act 306 of pausing VP(s). Notably, an arrow connecting act 305 and act 306 indicates that there is no strict ordering between these acts. Thus, in various embodiments, act 305 and act 306 are performed serially (in either order), or at least partially in parallel.

In some embodiments, act 305 comprises holding the interrupt at the hypervisor based on the interrupt being the root interrupt type. For example, interrupt management component 202 queues the root interrupt (interrupt queue 122) for later delivery to root partition 109.

In some embodiments, act 306 comprises suspending the VP based on the interrupt being the root interrupt type. For example, VP management component 203 suspends VP 118a, which originated the interrupt. As mentioned, in embodiments, depending on the type of the root interrupt, the component being serviced, etc., interrupt management component 202 may trigger suspension of all of a guest VM(s) VPs, or only a subset thereof (e.g., just the VP that triggered the interrupt). Thus, in some embodiments of act 306, suspending the VP comprises suspending all VPs of the partition associated with the VM. Notably, in instances where all VPs are suspended, some embodiments also freeze a timer associated with the partition. Thus, in embodiments, act 306 also comprises freezing a partition reference time for the partition based on suspending all the VPs of the partition.

Although not shown in FIGS. 3A-3B, in some embodiments, interrupt management component 202 only holds a root interrupt and suspends a VP if the root interrupt is handled by the component being serviced; otherwise, the servicing component 121 permits the interrupt to proceed normally. Thus, in some embodiments, before holding the interrupt at the hypervisor and suspending the VP, method 300 determines that processing the interrupt would rely on the component of the virtualization stack to which the servicing operation applies.

Following the “Synthetic” branch from act 304, in some instances, based on determining that the interrupt is the synthetic interrupt type in act 304, method 300 comprises act 307 of holding the interrupt. In other instances, based on determining that the interrupt is the synthetic interrupt type in act 304, method 300 comprises or act 308 of returning a timeout status.

In some embodiments, act 307 comprises, based on the interrupt being the synthetic interrupt type, holding the interrupt at the hypervisor while permitting the VP to continue running. For example, interrupt management component 202 queues the synthetic interrupt (interrupt queue 122) for later delivery to root partition 109, but does not suspend any VP. In embodiments, if some limit is reached (e.g., a number or frequency of held synthetic interrupts for VP 118a), interrupt management component 202 clears the held synthetic interrupts and returns a timeout status to VP 118a.

In some embodiments, act 308 comprises, based on the interrupt being the synthetic interrupt type, returning a timeout status while permitting the VP to continue running. For example, interrupt management component 202 returns a timeout status to VP 118a.

Notably, arrows extending from act 306 and act 308 to act 303 indicate that method 300 can operate on any number of root or synthetic interrupts for a given partition during a servicing operation.

Turning to FIG. 3B, method 300 also comprises act 309 of detecting the completion of the servicing operation. For example, the auto-suspend management component 201 determines that servicing the virtualization stack component (e.g., host OS 111, one or more of VM support components 119, hypervisor 108) has been completed. In embodiments, based on determining that servicing the virtualization stack component has been completed, the auto-suspend management component 201 clears the partition property that was set in act 301.

After detecting the completion of the servicing operation in act 309, method 300 also comprises act 310 of resuming any suspended VP(s) and act 311 of releasing any held interrupts. Notably, no strict ordering is required between act 310 and act 311. Thus, in various embodiments, act 310 and act 311 are performed serially (in either order) or at least partially in parallel.

In some embodiments, act 310 comprises, after completion of the servicing operation, resuming the VP(s). For example, VP management component 203 resumes VP 118a, which was suspended in act 306. As mentioned, in some embodiments of act 306, suspending the VP comprises suspending all VPs of the partition associated with the VM. In these embodiments, act 310 comprises resuming all the VPs of the partition. Additionally, as mentioned, in instances where all VPs are suspended, some embodiments of act 306 comprise freezing a partition reference time for the partition based on suspending all the VPs of the partition. In these embodiments, act 310 comprises resuming the partition reference time based on resuming all the VPs of the partition.

In some embodiments, act 311 comprises releasing interrupt(s) after completion of the servicing operation. For example, interrupt management component 202 releases any held root and/or synthetic interrupts for guest partition 110a to root partition 109.

Although not expressly illustrated in FIGS. 3A-3B, some embodiments of method 300 include saving and restoring the state of the component(s) being serviced. Thus, for example, some embodiments include state management component 204 saving a state of the component of the virtualization stack and then restoring the state of the component of the virtualization stack after servicing the component of the virtualization stack.

As mentioned in connection with state management component 204, some embodiments serialize a component's state into a state blob, service that component, and then deserialize the state blob to restore the component's state. Thus, in some embodiments, saving the state of the component of the virtualization stack comprises creating a backup record comprising an entirety of the state of the component of the virtualization stack, and restoring the state of the component of the virtualization stack comprises restoring the backup record as the state of the component of the virtualization stack.

As also mentioned in connection with state management component 204, other embodiments provide flexibility to handle state changes caused by the running VP(s) by defining an outline of a component's state that can or cannot be perturbed during the servicing of that component and then merging and/or reconciling the saved state with the existing values based on these defined boundaries. Thus, in some embodiments, saving the state of the component of the virtualization stack comprises creating a backup record comprising less than an entirety of the state of the component of the virtualization stack, and restoring the state of the component of the virtualization stack comprises reconciling the backup record with a portion of the state that was permuted while servicing the component of the virtualization stack.

Embodiments of the disclosure comprise or utilize a special-purpose or general-purpose computer system (e.g., computer system 101) that includes computer hardware, such as, for example, a processor system (e.g., processor system 103) and system memory (e.g., memory 104), as discussed in greater detail below. Embodiments within the scope of the present disclosure also include physical and other computer-readable media for carrying or storing computer-executable instructions and/or data structures. Such computer-readable media can be any available media accessible by a general-purpose or special-purpose computer system. Computer-readable media that store computer-executable instructions and/or data structures are computer storage media (e.g., storage medium 105). Computer-readable media that carry computer-executable instructions and/or data structures are transmission media. Thus, embodiments of the disclosure can comprise at least two distinctly different kinds of computer-readable media: computer storage media and transmission media.

Computer storage media are physical storage media that store computer-executable instructions and/or data structures. Physical storage media include computer hardware, such as random access memory (RAM), read-only memory (ROM), electrically erasable programmable ROM (EEPROM), solid state drives (SSDs), flash memory, phase-change memory (PCM), optical disk storage, magnetic disk storage or other magnetic storage devices, or any other hardware storage device(s) which store program code in the form of computer-executable instructions or data structures, which can be accessed and executed by a general-purpose or special-purpose computer system to implement the disclosed functionality.

Transmission media include a network and/or data links that carry program code in the form of computer-executable instructions or data structures that are accessible by a general-purpose or special-purpose computer system. A “network” is defined as a data link that enables the transport of electronic data between computer systems and other electronic devices. When information is transferred or provided over a network or another communications connection (either hardwired, wireless, or a combination thereof) to a computer system, the computer system may view the connection as transmission media. The scope of computer-readable media includes combinations thereof.

Upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., network interface 106) and eventually transferred to computer system RAM and/or less volatile computer storage media at a computer system. Thus, computer storage media can be included in computer system components that also utilize transmission media.

Computer-executable instructions comprise, for example, instructions and data which when executed at a processor system, cause a general-purpose computer system, a special-purpose computer system, or a special-purpose processing device to perform a function or group of functions. In embodiments, computer-executable instructions comprise binaries, intermediate format instructions (e.g., assembly language), or source code. In embodiments, a processor system comprises one or more central processing units (CPUs), one or more graphics processing units (GPUs), one or more neural processing units (NPUs), and the like.

In some embodiments, the disclosed systems and methods are practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. In some embodiments, the disclosed systems and methods are practiced in distributed system environments where different computer systems, which are linked through a network (e.g., by hardwired data links, wireless data links, or by a combination of hardwired and wireless data links), both perform tasks. As such, in a distributed system environment, a computer system may include a plurality of constituent computer systems. Program modules may be located in local and remote memory storage devices in a distributed system environment.

In some embodiments, the disclosed systems and methods are practiced in a cloud computing environment. In some embodiments, cloud computing environments are distributed, although this is not required. When distributed, cloud computing environments may be distributed internally within an organization and/or have components possessed across multiple organizations. In this description and the following claims, “cloud computing” is a model for enabling on-demand network access to a shared pool of configurable computing resources (e.g., networks, servers, storage, applications, and services). A cloud computing model can be composed of various characteristics, such as on-demand self-service, broad network access, resource pooling, rapid elasticity, measured service, and so forth. A cloud computing model may also come in the form of various service models such as software as a service (SaaS), platform as a service (PaaS), infrastructure as a service (IaaS), etc. The cloud computing model may also be deployed using different deployment models such as private cloud, community cloud, public cloud, hybrid cloud, etc.

Some embodiments, such as a cloud computing environment, comprise a system with one or more hosts capable of running one or more VMs. During operation, VMs emulate an operational computing system, supporting an OS and perhaps one or more other applications. In some embodiments, each host includes a hypervisor that emulates virtual resources for the VMs using physical resources that are abstracted from the view of the VMs. The hypervisor also provides proper isolation between the VMs. Thus, from the perspective of any given VM, the hypervisor provides the illusion that the VM is interfacing with a physical resource, even though the VM only interfaces with the appearance (e.g., a virtual resource) of a physical resource. Examples of physical resources include processing capacity, memory, disk space, network bandwidth, media drives, and so forth.

Although the subject matter has been described in language specific to structural features and/or methodological acts, it is to be understood that the subject matter defined in the appended claims is not necessarily limited to the described features or acts described supra or the order of the acts described supra. Instead, the described features and acts are disclosed as example forms of implementing the claims.

The present disclosure may be embodied in other specific forms without departing from its essential characteristics. The described embodiments are only illustrative and not restrictive. All changes that come within the meaning and range of equivalency of the claims are to be embraced within their scope.

When introducing elements in the appended claims, the articles “a,” “an,” “the,” and “said” are intended to mean there are one or more of the elements. The terms “comprising,” “including,” and “having” are intended to be inclusive and mean that there may be additional elements other than the listed elements. Unless otherwise specified, the terms “set,” “superset,” and “subset” are intended to exclude an empty set, and thus “set” is defined as a non-empty set, “superset” is defined as a non-empty superset, and “subset” is defined as a non-empty subset. Unless otherwise specified, the term “subset” excludes the entirety of its superset (i.e., the superset contains at least one item not included in the subset). Unless otherwise specified, a “superset” can include at least one additional element, and a “subset” can exclude at least one element.

What is claimed:

1. A method implemented in a computer system that includes a processor system, comprising:
detecting a servicing operation for a component of a virtualization stack that supports execution of a virtual machine (VM);
detecting a first interrupt from a first virtual processor (VP) of a partition associated with the VM while the component of the virtualization stack is being serviced;
determining that the first interrupt is a root interrupt type;
based on the first interrupt being the root interrupt type:
holding the first interrupt at a hypervisor; and
suspending the first VP; and
after completion of the servicing operation:
resuming the first VP; and
releasing the first interrupt to a root partition.

2. The method of claim 1, wherein the method further comprises:
setting a partition property for the partition associated with the VM, the partition property indicating an auto-suspend mode that allows one or more VPs associated with the partition to continue running unless the VP generates an interrupt of the root interrupt type; and
clearing the partition property after the completion of the servicing operation.

3. The method of claim 2, wherein the partition property is set by a hypercall from the virtualization stack to the hypervisor.

4. The method of claim 1, wherein the method further comprises:
saving a state of the component of the virtualization stack;
servicing the component of the virtualization stack; and
restoring the state of the component of the virtualization stack.

5. The method of claim 4, wherein,
saving the state of the component of the virtualization stack comprises creating a backup record comprising an entirety of the state of the component of the virtualization stack; and
restoring the state of the component of the virtualization stack comprises restoring the backup record as the state of the component of the virtualization stack.

6. The method of claim 4, wherein,
saving the state of the component of the virtualization stack comprises creating a backup record comprising less than an entirety of the state of the component of the virtualization stack; and
restoring the state of the component of the virtualization stack comprises reconciling the backup record with a portion of the state that was permuted while servicing the component of the virtualization stack.

7. The method of claim 1, wherein the method further comprises:
detecting a second interrupt from a second VP of the partition associated with the VM while the component of the virtualization stack is being serviced;
determining that the second interrupt is a synthetic interrupt type; and
based on the second interrupt being the synthetic interrupt type:
holding the second interrupt at the hypervisor while permitting the second VP to continue running; or
returning a timeout status VP while permitting the second VP to continue running.

8. The method of claim 7, wherein the method further comprises releasing the second interrupt after the completion of the servicing operation.

9. The method of claim 1, wherein,
suspending the first VP comprises suspending all VPs of the partition associated with the VM; and
resuming the first VP comprises resuming all the VPs of the partition.

10. The method of claim 9, wherein the method further comprises:
freezing a partition reference time for the partition based on suspending all the VPs of the partition; and
resuming the partition reference time based on resuming all the VPs of the partition.

11. The method of claim 1, wherein the method further comprises, before holding the first interrupt at the hypervisor and suspending the first VP, determining that processing the first interrupt would rely on the component of the virtualization stack to which the servicing operation applies.

12. A computer system, comprising:
a processor system; and
a computer storage medium that stores computer-executable instructions that are executable by the processor system to at least:
detect a servicing operation for a component of a virtualization stack that supports execution of a virtual machine (VM);
detect a first interrupt from a first virtual processor (VP) of a partition associated with the VM while the component of the virtualization stack is being serviced;
determine that the first interrupt is a root interrupt type;
determine that processing of the first interrupt would rely on the component of the virtualization stack to which the servicing operation applies;
based on the first interrupt being the root interrupt type and based on processing of the first interrupt relying on the component of the virtualization stack to which the servicing operation applies:
hold the first interrupt at a hypervisor; and
suspend the first VP; and
after completion of the servicing operation for the component of the virtualization stack to which the servicing operation applies:
resume the first VP; and
release the first interrupt to a root partition.

13. The computer system of claim 12, wherein the computer-executable instructions are also executable by the processor system to at least:
set a partition property for the partition associated with the VM, the partition property indicating an auto-suspend mode that allows one or more VPs associated with the partition to continue running unless the VP generates an interrupt of the root interrupt type; and
clear the partition property after the completion of the servicing operation.

14. The computer system of claim 12, wherein the computer-executable instructions are also executable by the processor system to at least:
save a state of the component of the virtualization stack;
service the component of the virtualization stack; and
restore the state of the component of the virtualization stack.

15. The computer system of claim 14, wherein,
saving the state of the component of the virtualization stack comprises creating a backup record comprising an entirety of the state of the component of the virtualization stack; and
restoring the state of the component of the virtualization stack comprises restoring the backup record as the state of the component of the virtualization stack.

16. The computer system of claim 14, wherein,
saving the state of the component of the virtualization stack comprises creating a backup record comprising less than an entirety of the state of the component of the virtualization stack; and
restoring the state of the component of the virtualization stack comprises reconciling the backup record with a portion of the state that was permuted while servicing the component of the virtualization stack.

17. The computer system of claim 12, wherein the computer-executable instructions are also executable by the processor system to at least:
detect a second interrupt from a second VP of the partition associated with the VM while the component of the virtualization stack is being serviced;
determine that the second interrupt is a synthetic interrupt type;
based on the second interrupt being the synthetic interrupt type:
hold the second interrupt at the hypervisor while permitting the second VP to continue running; or
return a timeout status VP while permitting the second VP to continue running; and
release the second interrupt after the completion of the servicing operation.

18. The computer system of claim 12, wherein,
suspending the first VP comprises suspending all VPs of the partition associated with the VM; and
resuming the first VP comprises resuming all the VPs of the partition.

19. The computer system of claim 18, wherein the computer-executable instructions are also executable by the processor system to at least:
freeze a partition reference time for the partition based on suspending all the VPs of the partition; and
resume the partition reference time based on resuming all the VPs of the partition.

20. A computer storage medium that stores computer-executable instructions that are executable by a processor system to at least:
detect a servicing operation for a component of a virtualization stack that supports execution of a virtual machine (VM);
in response to detecting a first interrupt from a first virtual processor (VP) of a partition associated with the VM while the component of the virtualization stack is being serviced:
determine that the first interrupt is a root interrupt type; and
based on the first interrupt being the root interrupt type:
hold the first interrupt at a hypervisor; and
suspend the first VP;
in response to detecting a second interrupt from a second VP of the partition associated with the VM while the component of the virtualization stack is being serviced:
determine that the second interrupt is a synthetic interrupt type; and
based on the second interrupt being the synthetic interrupt type:
hold the second interrupt at the hypervisor while permitting the second VP to continue running; or
return a timeout status VP while permitting the second VP to continue running; and
after completion of the servicing operation:
resume the first VP; and
release the first interrupt to a root partition.
